(19) United States
(12) Patent Application Publication
(10) Pub. No.: US 2019/0271437 A1
(43) Pub. Date: Sep. 5, 2019

(54) BAR CLAMP

(71) Applicant: John L. Smith, Brooklyn, NY (US)

(72) Inventor: John L. Smith, Brooklyn, NY (US)

(21) Appl. No.: 16/151,381

(22) Filed: Oct. 4, 2018

Related U.S. Application Data
(60) Provisional application No. 62/637,540, filed on Mar. 2, 2018.

(51) Int. Cl. F16M 13/02; B44D 3/00

(52) U.S. Cl. CPC F16M 13/02; B44D 3/00

(57) ABSTRACT

A bar clamp formed into a hook shape to facilitate securing products such as works of art on a cloth material stretched over a stretcher bar system to a transport structure (e.g. crate or travel frame) for safe transport or storage. The bar clamp typically has 2 bends in one end, making a “hook” shape, to receive the interior edge of the stretcher, and an attachment mechanism at the opposite end for attaching by means of fasteners to the enclosed structure (e.g. crate or travel frame).

### CROSS-REFERENCE TO RELATED APPLICATION

The present application claims priority to U.S. Provisional Patent Application Ser. No. 62/637,540 filed Mar. 2, 2018 and entitled “STRETCHER HOOK” which is hereby incorporated herein by reference in entirety for all purposes.

### BACKGROUND

The bar clamp device disclosed relates to an alternative support member to secure products especially during transport of the product. For example to transport or store artwork, often a crate or traveling frame is required to protect the artwork. Artwork may be secured in place by frictional engagement on all six sides, however, in some cases, this may not be desirable due to the very nature of the artwork (i.e.—a delicate or wet primary surface). It is in these circumstances that an alternative method by which to secure the artwork in the crate or traveling frame is preferable.

One such method is to use “Ozclips” (U.S. Pat. No. 4,967,993, Nov. 1990, Wilson) attached to the back of the artwork and then in turn attached to the support surface/plane of the crate or traveling frame. However, if the “Ozclips” are not to remain on the back of the artwork upon removal from the crate or traveling frame, the screws attaching the “Ozclips” to the back of the artwork must be removed leaving holes. If the “Ozclips” are to be reattached for transport or storage, new screw holes may be needed as the previous holes may be unsuitable for re-use. As will be appreciated, this can eventually cause too much damage to the stretcher or frame resulting in the need for replacement.

Most paintings are sized so that extra canvas (painted or not) is pulled around the back side of the stretcher and attached to the stretcher with staples or in some cases (with older paintings) upholstery tacks. Putting screws through that part of the canvas in order to attach the “Ozclip” may lead to damage in the way of fraying which can lead to ripping.

### SUMMARY

It is an object of the disclosed bar clamp to provide a support member which alleviates the problems associated with the prior method of transport and storage of products such as artwork. But this product can be used to secure other products in addition to artwork

Disclosed is a bar clamp with a first end comprising a hook shape to be compatible with the shape of the product to be transported or stored. Typically the hook shape will receive 3 surfaces of a portion of the product to be transported and a second end of the elongate to attach to the support surface of the transport structure such as a crate or traveling frame. Immobility of the product such as artwork is achieved by attaching an appropriate number of bar clamps to, for example, stretcher bar systems in common use by artists to provide at least 2 opposing directional forces.

A bar clamp disclosed is formed into a hook shape to facilitate securing a product such as works of art on a cloth material stretched over a stretcher bar system, to a transport structure (such as a crate or travel frame) for safe transport or storage. The bar clamp has 1 or more bend(s) as needed to form a “hook” shape compatible with the design of the product to be transported. The hook shape receives the edge of the product to be transported such as a stretcher bar. The bar clamp is created to allow attaching to the transport structure at the opposite or second end. One method for attachment to the transport structure is providing one or more holes to accept bolts or allow the use of screws to secure to the transport structure. Another option is using a clamp to secure the opposite end of the bar clamp to the transport structure. Once secured the product such as artwork remains immobile by means of opposing mechanical force in the X, Y, and Z axes.

### BRIEF DESCRIPTION OF THE DRAWINGS

A further understanding of the invention can be obtained by reference to embodiments set forth in the illustrations of the accompanying drawings. The drawings are not intended to limit the scope of this invention but merely to clarify and exemplify the aspects of the invention.

FIG. 1 is a top view of an embodiment of a bar clamp according to the present invention.

FIG. 2 is a side elevation view of a bar clamp depicted on FIG. 1.

FIG. 3 is a bottom view of a bar clamp depicted on FIG. 1.

FIG. 4 is the second end elevation view of a bar clamp depicted on FIG. 1.

FIG. 5 is the first end elevation view of a bar clamp depicted on FIG. 1.

FIG. 6 is a top view of another embodiment of a bar clamp.

FIG. 7 is a side elevation view of a bar clamp depicted on FIG. 6.

FIG. 8 is a bottom view of a bar clamp depicted on FIG. 6.

FIG. 9 is the second end elevation view of a bar clamp depicted on FIG. 6.

FIG. 10 is the first end elevation view of a bar clamp depicted on FIG. 6.

FIG. 11 is a top view of another embodiment of a bar clamp.

FIG. 12 is a side elevation view of a bar clamp depicted on FIG. 11.

FIG. 13 is a bottom view of a bar clamp depicted on FIG. 11.

FIG. 14 is the second end elevation view of a bar clamp depicted on FIG. 11.

FIG. 15 is the first end elevation view of a bar clamp depicted on FIG. 11.

FIG. 16 is a top view of another embodiment of a bar clamp.

FIG. 17 is a side elevation view of a bar clamp depicted on FIG. 11.

FIG. 18 is a bottom view of a bar clamp depicted on FIG. 11.

FIG. 19 is the second end elevation view of a bar clamp depicted on FIG. 11.

FIG. 20 is the first end elevation view of a bar clamp depicted on FIG. 11.

FIG. 21 is a side elevation view of an embodiment of a bar clamp with the first end in contact with the interior surfaces of a typical stretcher bar and the second end resting on the support surface of a crate or traveling frame.

FIG. 22 is a side elevation view of an embodiment of a bar clamp with the first end in contact with the interior surfaces of a typical stretcher bar and the second end resting on the support surface of a crate or traveling frame.

FIG. 23 is a side elevation view of an embodiment of a bar clamp with the first end in contact with the interior surfaces of a typical stretcher bar and the second end resting on the support surface of a crate or traveling frame.

FIG. 24 is a side elevation view of an embodiment of a bar clamp with the first end in contact with the interior surfaces of a typical stretcher bar and the second end resting on the support surface of a crate or traveling frame.

FIG. 25 is a side elevation view of an embodiment of a bar clamp with the first end in contact with the interior surfaces of a typical stretcher bar and the second end resting on the support surface of a crate or traveling frame.

FIG. 26 is a side elevation view of an embodiment of a bar clamp with the first end in contact with the interior surfaces of a typical stretcher bar and the second end resting on the support surface of a crate or traveling frame.

FIGS. 27 and 28 are perspective views of the bar clamp on FIG. 2.

FIG. 29 is a perspective view from the first end of the bar clamp attached to the 3 interior surfaces of a typical stretcher bar.

FIG. 30 is a perspective view from the second end of the bar clamp attached to the 3 interior surfaces of a typical stretcher bar.

### DETAILED DESCRIPTION

The bar clamp disclosed may be understood more readily by reference to the following description of embodiments of the bar clamp. However, techniques, systems, operating structures and manufacturing materials may be embodied in a wide variety of forms and modes, some of which may be quite different from those disclosed. Consequently, the specific structural and functional details disclosed herein are merely representative of possible configurations. It must be noted that, as used in the specification the singular forms “a”, “an”, and “the” include plural referents unless the context clearly indicates otherwise.

Disclosed are multiple embodiments of a bar clamp 10. The bar clamp may be used to secure a product such as artwork in a crate or traveling frame for transport or storage. As such, the bar clamp 10 may be of varying sizes and configurations to accommodate the different embodiments of stretcher bar systems in common use by artists.

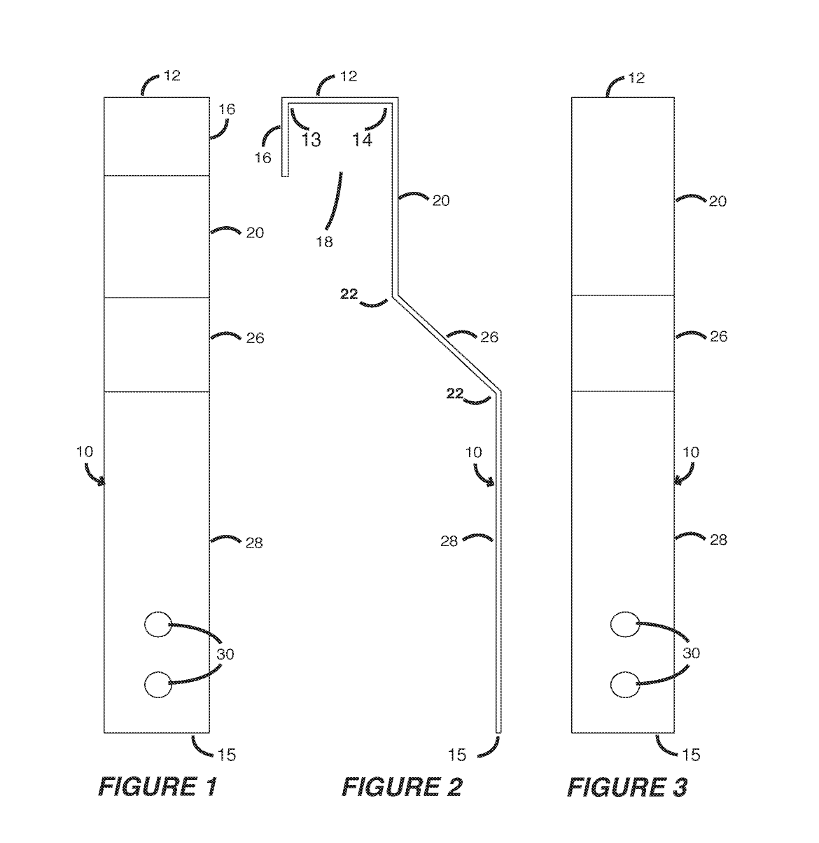

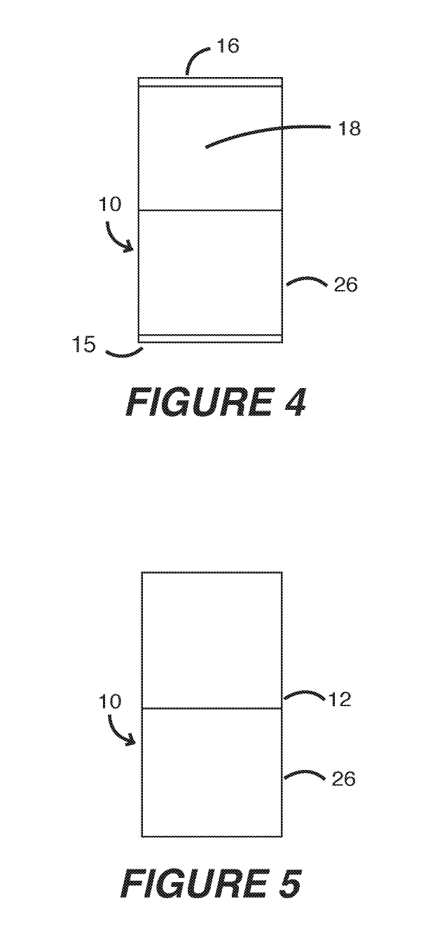

According to one embodiment, as illustrated in FIGS. 1-5, a bar clamp 10 has two ends with a hook shape 18 at the first end 11, a planar surface 20 at the second end extending from the hook shape 18 to an offset 19 in the bar clamp, and further extending to a surface 28 at the second end 15 of the bar clamp. The hook 18 comprises an upper surface 16 extending from a first end 11 to a connecting surface 12 and to a lower surface 20. The combination of the 3 surfaces 12, 16, and 20 captures an object such as a transport structure to prevent movement.

On FIG. 2 the angle 13 between the upper surface 16 and the connecting surface 12, and the angle 14 between the connecting surface 12 and the lower surface 20 are 90 degrees but can be varied as needed to be compatible with the product 34 to be transported or stored. The lower surface 20 is typically longer than the upper surface 16 to provide contact support to the underside of a transport structure such as a stretcher bar.

The shape and dimensions of the hook 18 can be designed to match the configuration of the portion of the transport structure 32 which is to be attached. For example FIG. 12 shows the hook 18 formed in an arc shape.

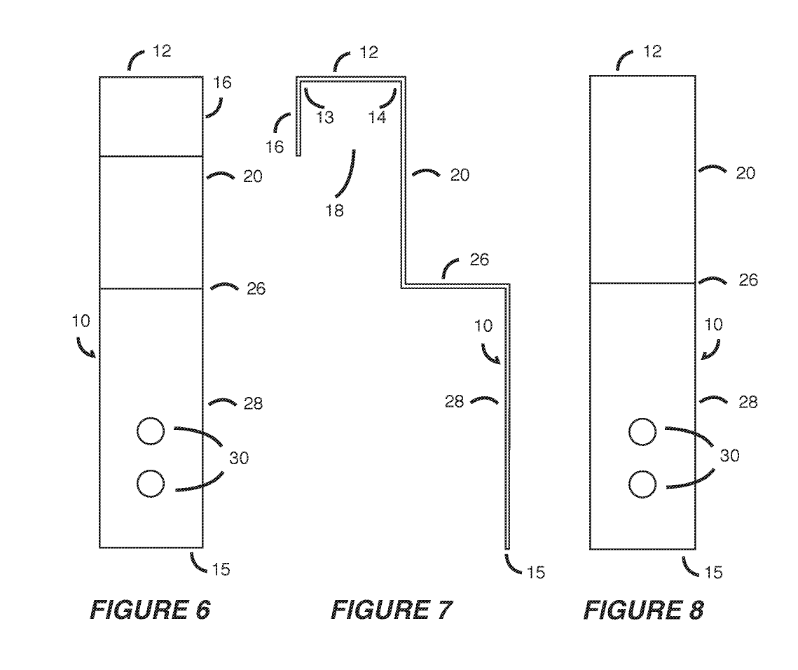

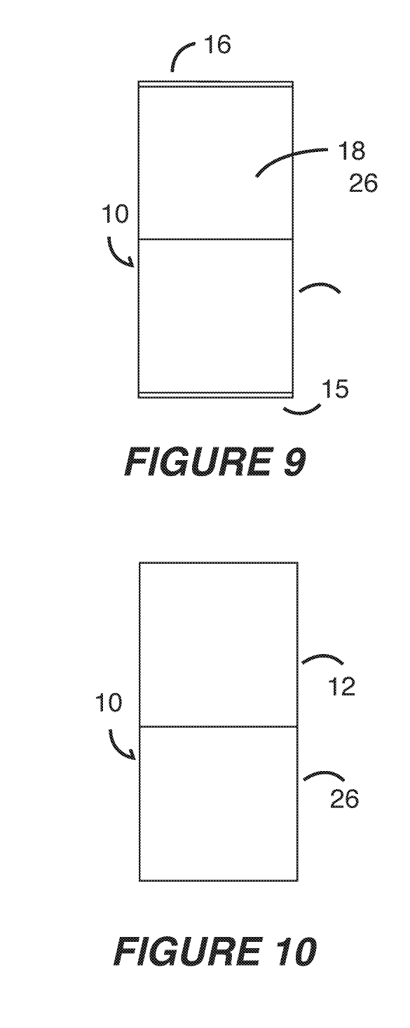

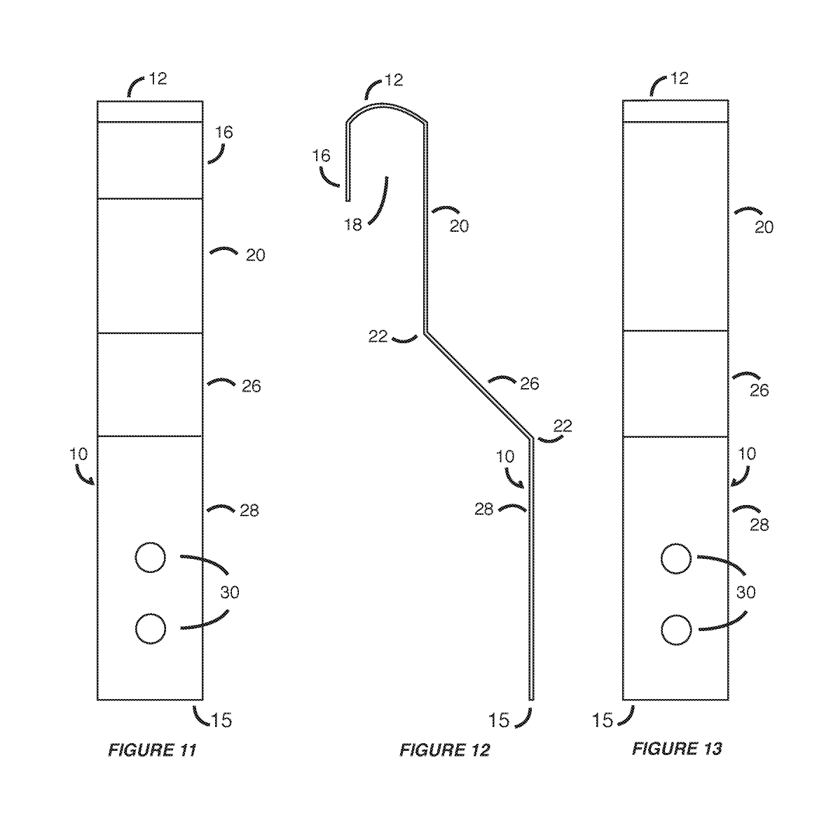

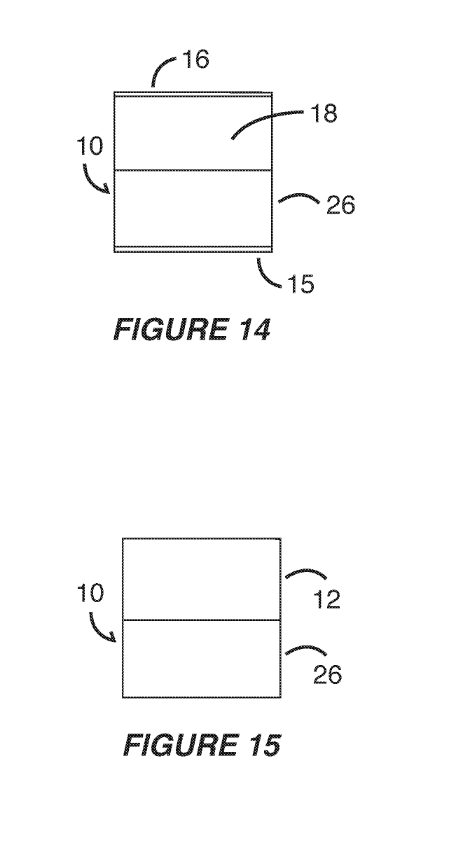

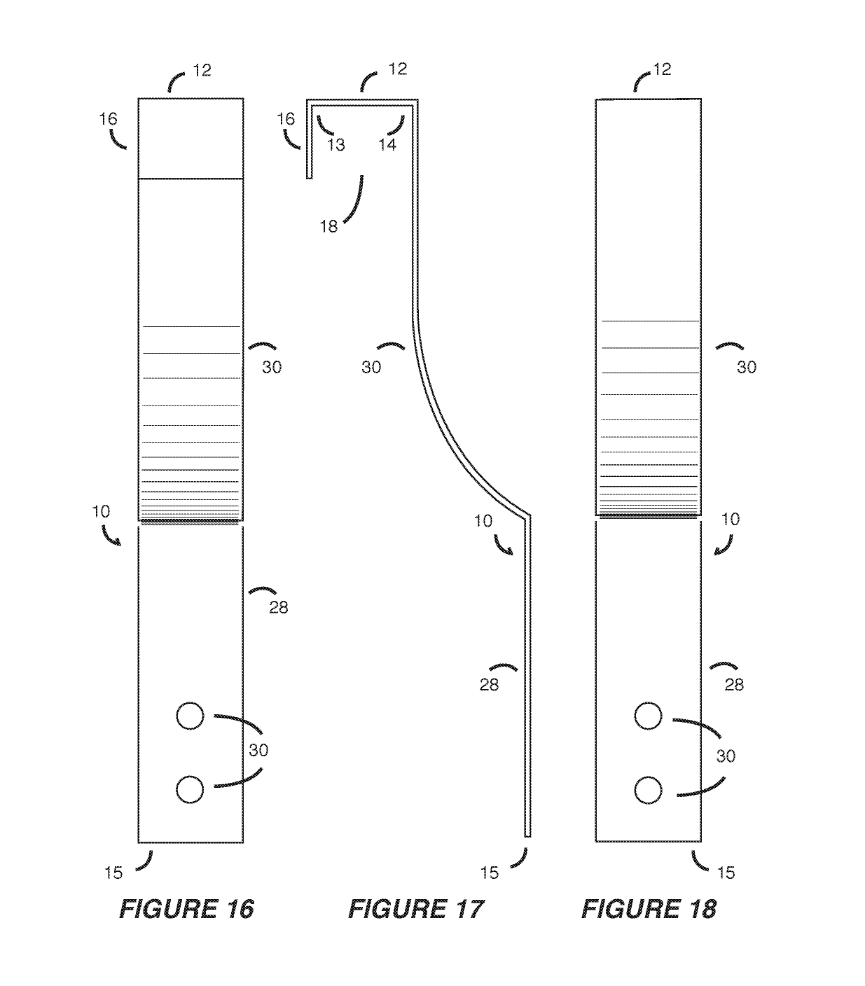

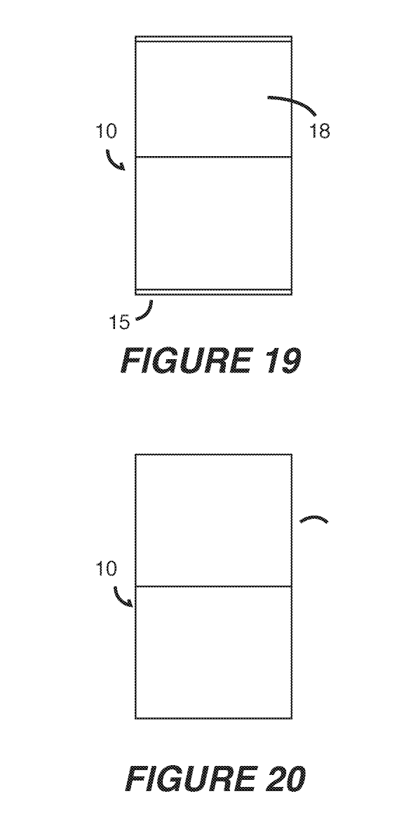

FIGS. 6-10 and 11-15 depict other examples of the bar clamp with the angles and dimensions are varied to be compatible with the particular application. FIGS. 16-20 depict an embodiment in which a continuous section 30 extends from the hook shape 18 to the surface 28. The continuous section 30 can be formed as an arc as depicted on FIG. 26 or any other shape compatible with the product to be secured. The surface 28, which ends at the second end 15, is typically longer than the lower surface 20, and may have 1 or more pass through holes 30, for securing the bar clamp 10 to the support surface 32 of the transport structure such as a crate or traveling frame.

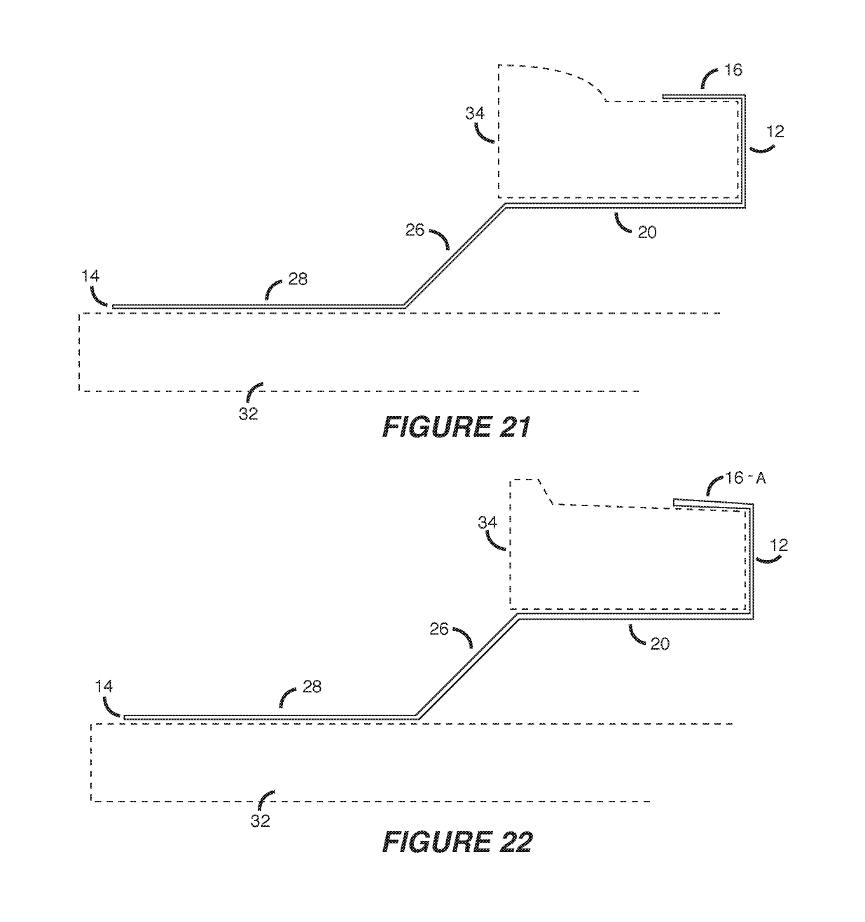

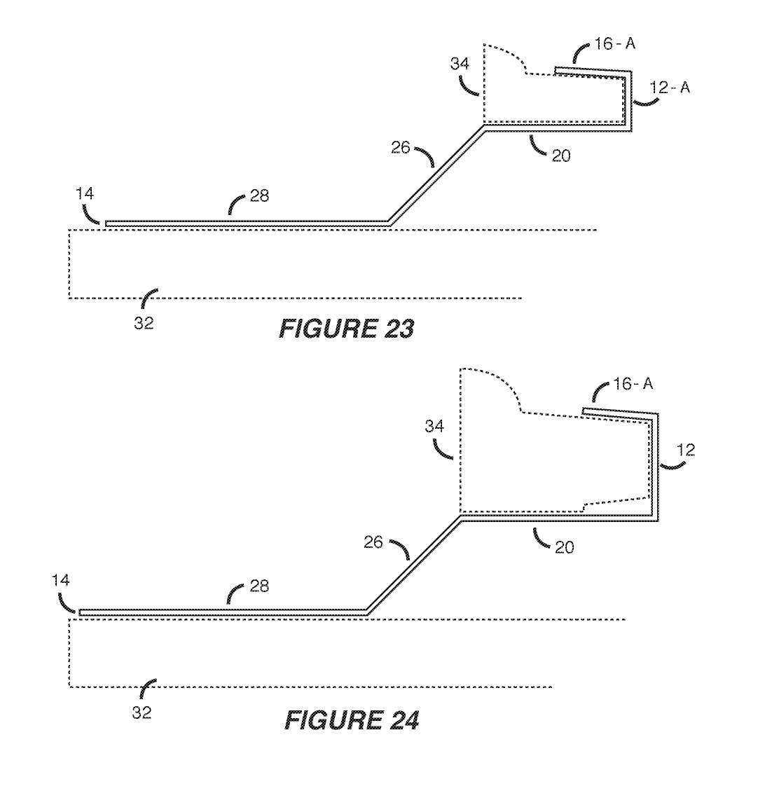

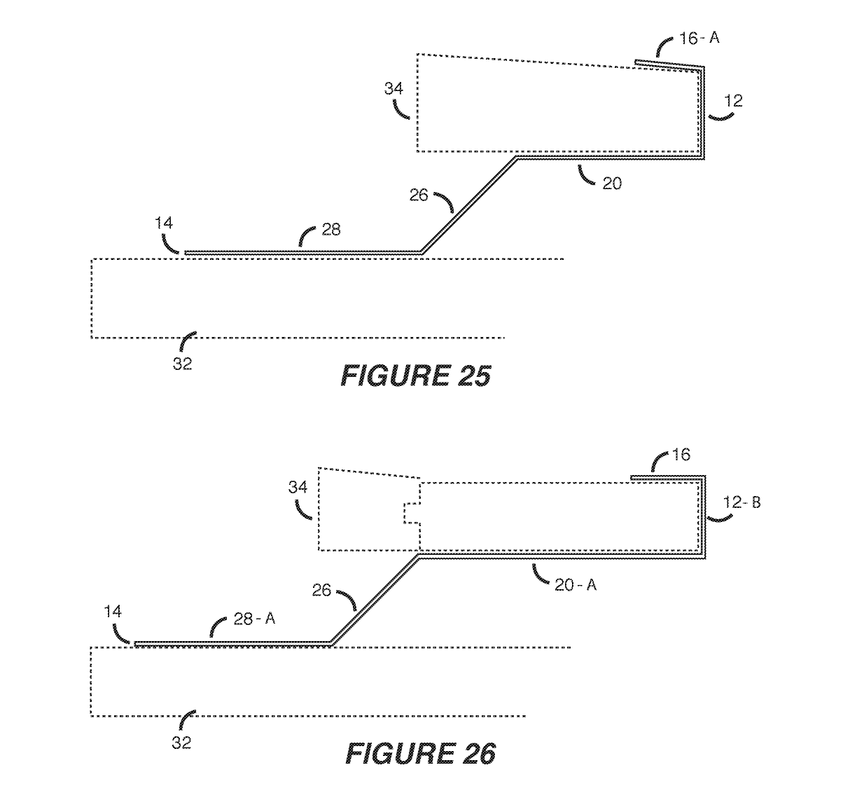

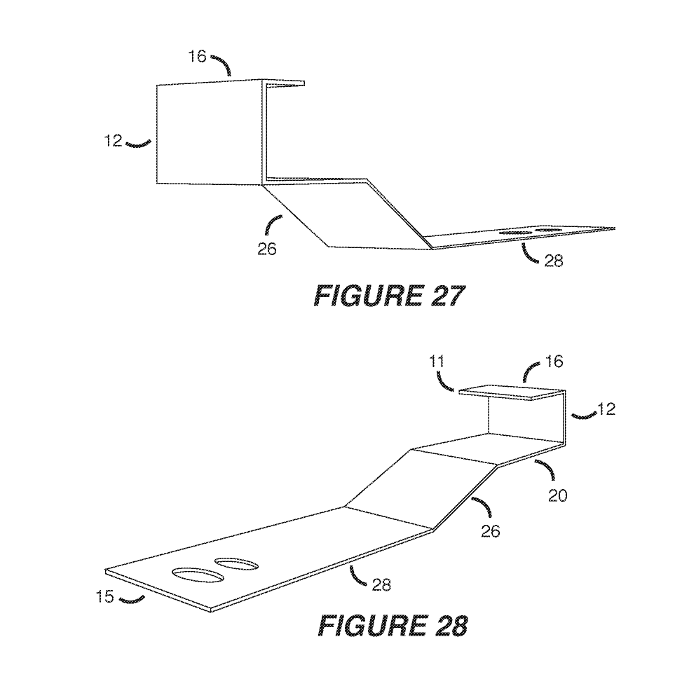

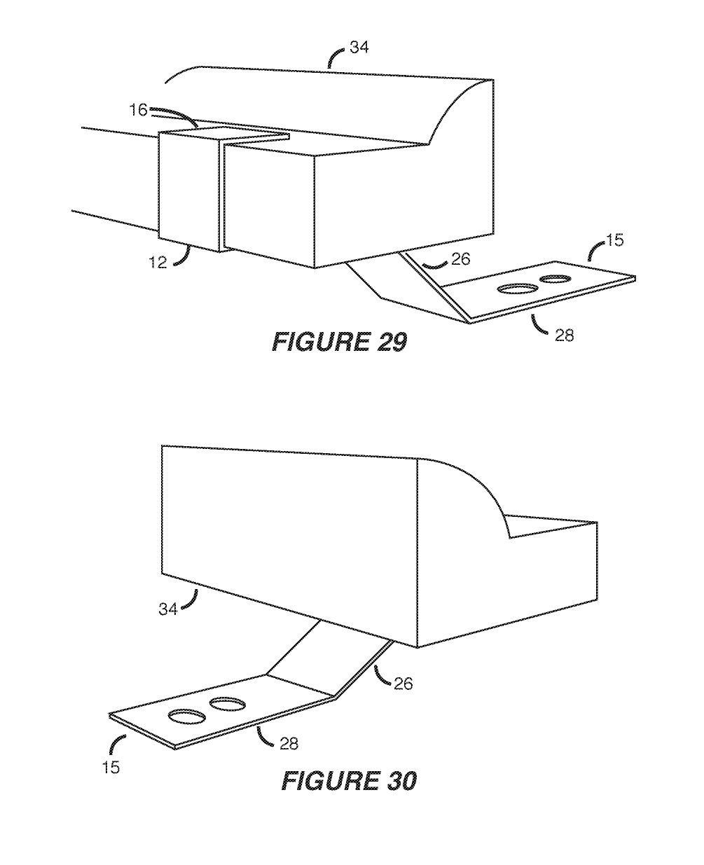

The bar clamp is typically configured to provide an offset between the hook 18 and the opposite end 15 making it easier to remove the product such as artwork from a crate or traveling frame. Thus on FIGS. 2, 7 and 12 embodiment angles 21 and 22 between surface 20 and surface 28 creates surface 26 and raises surface 20 above that of surface 28. Typically angles 21 and 22 are 90 degrees as depicted on FIG. 7 but can be varied as needed to be compatible with the product 34 to be transported or stored and the transport structure 32 as shown for example on FIGS. 21-29.

FIGS. 21-29 depict examples of different configurations of a bar clamp planar cross section with a bar clamp 10 installed on a typical stretcher bar 34 and a transport or storage structure 32 such as a crate or traveling frame. Not shown are the means of attachment of the bar clamp to the support structure such as using 1 or more bolts and nuts or screws for securing surface 28 of the bar clamp 10 to a transport structure 32.

FIGS. 7, 8, 9, and 10 illustrate features of other embodiments in which the upper surface 16 has a slight upwards angle to accommodate another configuration of stretcher bar having a sloping surface towards the interior of the stretcher bar. The angle can be designed to match the configuration of the support structure.

As shown on the Figures in other embodiments, the length of surfaces 12, 16, 20, 26, and 28 as well as the degree of angles 13, 14, 21, and 22 can be modified as required by the particular product 34 and support structure 32 for which the bar clamp will be used. On FIG. 8 the connecting surface 12 is shorter to accommodate another type of stretcher bar with a thinner overall profile and a sloping surface towards the interior of the stretcher bar. In one embodiment the bar clamp comprises: a first end and a second end; a hook shape at the first end; a planar surface extending from the hook shape to an offset in the bar clamp, and further extending to a planar surface at the second end.

In another embodiment the hook shape is formed by a minimum of one bend in the bar clamp between the first end and the planar surface extending from the hook shape. And the offset can be formed by two angled bends in the bar clamp causing the planar surface extending from the hook shape to be parallel to the planar surface extending to the second end.

In another embodiment the bar clamp comprises: a first end and a second end;

a hook shape at the first end; and an arc shaped surface extending from the hook shape to a planar surface extending to the second end. The hook shape can be formed by a minimum of one bend in the bar clamp between the first end and the arc shaped surface extending to the planar surface extending to the second end.

The above is a detailed description of particular embodiments of the invention. It is recognized that departures from the disclosed embodiments may be made within the scope of the invention and that obvious modifications will occur to a person skilled in the art. Those skilled in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

I claim:

1. A bar clamp comprising:
a first end and a second end;
a hook shape at the first end; and
a planar surface extending from the hook shape to an offset in the bar clamp, and further extending to a planar surface at the second end.

2. A bar clamp according to claim 1 wherein the hook shape is formed by a minimum of one bend in the bar clamp between the first end and the planar surface extending from the hook shape.

3. A bar clamp according to claim 2 wherein the offset is formed by two angled bends in the bar clamp causing the planar surface extending from the hook shape to be parallel to the planar surface extending to the second end.

4. A bar clamp according to claim 1 2 wherein the offset is formed by two angled bends in the bar clamp causing the planar surface extending from the hook shape to be parallel to the planar surface at the second end.

5. A bar clamp according to claim 2 wherein the hook shape is formed by a bend created in an arc shape in the bar clamp.

6. A bar clamp according to claim 5 wherein the arc shape in the bar clamp is in between a planar surface extending from the first end and the planar surface extending from the hook shape to the offset.

7. A bar clamp according to claim 1 wherein the hook shape is created to be compatible with a product to be secured using the bar clamp.

8. A bar clamp according to claim 7 wherein the offset is formed by two angled bends in the bar clamp between the planar surface extending from the hook shape and the planar surface at the second end.

9. A bar clamp according to claim 7 wherein the hook shape is formed by a bend created as an arc shape in the bar clamp.

10. A bar clamp according to claim 7 wherein the planar surface at the second end includes a minimum of one hole created for use in the attachment of the bar clamp to a transport structure.

11. A bar clamp comprising:
a first end and a second end;
a hook shape at the first end;
an arc shaped surface extending from the hook shape to a planar surface extending to the second end.

12. A bar clamp according to claim 11 wherein the hook shape is formed by a minimum of one bend in the bar clamp between the first end and the arc shaped surface extending to the planar surface extending to the second end.

13. A bar clamp according to claim 11 wherein the hook shape is formed by a bend created in an arc shape.

14. A bar clamp according to claim 11 wherein the planar surface at the second end includes a minimum of one hole created for use in the attachment of the bar clamp to a transport structure.
